(19) United States
(12) Patent Application Publication
(10) Pub. No.: US 2007/0014917 A1
(43) Pub. Date: Jan. 18, 2007

(54) Functionalization of oxidic particle surfaces, particles thus obtained, and the use thereof

(76) Inventors: Michael Binnewies, Muenster (DE); Thomas Glesenberg, Oberwil (CH)

Correspondence Address: HENKEL CORPORATION, THE TRIAD, SUITE 200, 2200 RENAISSANCE BLVD., GULPH MILLS, PA, 19406, US

(21) Appl. No.: 11/453,779

(22) Filed: Jun. 14, 2006

Related U.S. Application Data
(63) Continuation of application No. PCT/EP04/14323, filed on Dec. 16, 2004.

(30) Foreign Application Priority Data
Dec. 19, 2003 (DE) 103 59 840.5

(51) Int. Cl. B32B 15/02; C04B 35/00

(52) U.S. Cl. 427/212; 428/404; 252/62.52; 51/309; 106/401; 106/431; 106/435; 106/446; 106/450; 106/452; 106/454; 106/455; 106/457; 106/465; 106/471; 106/479; 106/480; 106/490; 106/499; 106/287.27; 106/287.16; 106/287.12; 106/287.13; 106/287.14; 502/158; 502/240

(57) ABSTRACT

A method for the surface modification of particles containing oxidic compounds of metals and/or semimetals M having M-O—H groups on the surface thereof. The particles are contacted with silicon-halogen compounds under conditions such that the M-O—H groups react with the silicon-halogen compounds. The particles thus produced can have Si—OH, Si-Halogen, and/or Si-Organic Radical groups in a density of at least two such groups per nm² surface and/or have at least four carbon atoms corresponding to the Si-Organic Radical groups per nm² of surface.

### CROSS-REFERENCE TO RELATED APPLICATIONS

This application is a continuation under 35 USC Sections 365(c) and 120 of International Application No. PCT/EP2004/014323, filed 16 Dec. 2004 and published 7 Jul. 2005 as WO 2005/061631, which claims priority from German Application No. 10359840.5 filed 19 Dec. 2003, each of which is incorporated herein by reference in its entirety.

### FIELD OF THE INVENTION

The invention relates to a process for the functionalization of surfaces of amorphous or crystalline compounds (particles) that comprise firstly a metal or semimetal that is not exclusively silicon, and secondly oxygen. The invention further relates to particles that are obtained in this way and their various uses.

### DISCUSSION OF THE RELATED ART AND BRIEF SUMMARY OF THE INVENTION

Inorganic particles are used, for example, as reinforcing fillers, catalysts, catalyst supports, pigments, and materials having particular mechanical, electrical, dielectric, magnetic or optical properties. The properties and condition of the inorganic particle surface are of crucial importance for their use in inorganic/organic hybrid materials.

The present invention described herein provides a process that permits the surfaces of particles of the described composition, preferably oxides, particularly preferably metal oxides, to be chemically modified in such a way that they correspond in an optimal manner to the respective intended use.

A substantial prior art exists for the surface modification of oxidic particles. For example, the surface modification can consist of a hydrophobing process. This involves coating the oxidic surfaces with organic compounds in such a way that non-polar groups of the organic compounds lay on the particle surface. This can be effected, for example, by treating the oxidic particles with alcohols, alcoholates, carboxylic acids, carboxylic acid chlorides or with organosilicon compounds. EP-A-1 284 277, for example, describes silicon dioxide-encapsulated metal oxide particles. These are prepared by adding, with stirring, a base dissolved in water to a dispersion that comprises a metal oxide and a compound of the type XₙSi(OR)₄₋ₙ. The reaction product is separated from the aqueous phase, optionally washed and dried. The metal oxides can include, for example, titanium dioxide, zinc oxide, zirconium oxide, iron oxide, cerium oxide or mixtures of these oxides with aluminum oxide or silicon dioxide. The resulting particles are suitable, for example, as sun screening agents, as UV-filters, for the manufacture of dispersions and in chemical-mechanical polishing processes.

The publication by Giesenberg, Hein, Binnewies and Kickelbick: “Synthesis and Functionalization of a New Type of Silicon Dioxide Particles” (Angew. Chem. Int. Ed. 2004 (43), pages 5697 to 5700), which was published after the priority date of the present patent application, describes the gas-phase reaction of silicon tetrachloride with oxygen to afford “silicon dioxide” particles that still comprise a substantial residual content of Si—Cl groups. The greater part of the chlorine atoms lay on the particle surface. They are therefore available for further chemical reactions. The surface Si—Cl groups can be hydrolyzed with water or react with alcohols, amines, alkyllithiums or with Grignard reagents to afford the corresponding derivatives. In this way, particles are obtained whose surfaces are functionalized to a substantially higher degree than is possible by the classical functionalization of silicon dioxide particles. In this way, the dispersibility of the particles in non-polar media is improved.

The object of the present invention is to also functionalize oxidic particles other than silicon dioxide particles, in substantially higher yields than is made possible by the prior art.

This object is achieved by the inventive superimposition of a layer of silicon/oxygen/halogen compounds, preferably silicon/oxygen/chlorine compounds, on the surface of the respective particles. The thickness of the inventive superimposed layer can be up to a micrometer. The functionality of the layer is obtained due to the fact that the silicon atoms that are inventively fixed to the particle surface are still bonded to one to three chlorine atoms. Once again, they can easily be replaced by practically all other substituents, preferably organic groups. For example, the total or partial substitution of the chlorine atoms by long chain hydrocarbon groups affords hydrophobic particles that prefer the organic phase in water/toluene. The inventive functionalized particle can also carry 2, 3 or more materially different functional groups.

### DETAILED DESCRIPTION OF CERTAIN EMBODIMENTS OF THE INVENTION

In a first aspect, the invention relates to a process for the surface modification of particles of oxidic compounds of metals and/or semimetals M, having M-O—H groups on the surface thereof, and not containing exclusively silicon as the metal or semimetal M, wherein particles are brought into contact with silicon-halogen compounds in a reaction step b) under conditions such that the M-O—H groups react with the silicon-halogen compounds to afford M-O—Si—X groups (X=halogen).

That the particles should not exclusively comprise silicon as the semimetal M means that they are not intended to consist of silicon dioxide or “silicas”. Nevertheless, the metallic or semimetallic component M can partially consist of silicon, as is the case, for example, in aluminosilicate minerals. These types of compounds, such as, for example layered silicates like mica, bentonite etc. are encompassed by the present invention. Further, non-restricting examples of the oxidic compounds encompassed by the invention are titanium dioxide, zirconium oxide, zinc oxide, iron oxide, nickel oxide, manganese oxide, cerium oxide, aluminum oxide or also mixed oxides that comprise the metals titanium, zinc, zirconium, iron, cobalt, nickel, cerium and/or aluminum.

In this context, the particles may have any particle size and particle size distribution. For example, they can be nanoscale, i.e., with mean particle size less than 1 μm. These types of particle can be manufactured pyrogenically, for example. Similarly, particles with a mean size in the micrometer range, i.e., between 1 μm and 1 mm are included. According to the application purpose, the particle size can also exceed 1 mm. Finally, the “particles” can also be macroscopic objects, whose surfaces are modified according to the invention.

Even when there are no M-O—H groups given in the chemical formula of the oxidic compounds, such groups are, however, always present on the particle surface to saturate the valency. It can be established that this is indeed the case, as the reaction with silicon-halogen compounds can be detected. Should a density of M-O—H groups on the particle surface be required for reaction with silicon-halogen compounds that is higher than is usually the case for the oxidic particles, then the number of M-O—H groups on the particle surface can be increased by contacting the particle surface with a strong acid in a reaction step a) prior to reaction step b). This is preferably carried out in the aqueous phase and under conditions, in which the oxidic particles are indeed attacked, but however not dissolved. The variable parameters here are particularly the strength of the acid, the reaction temperature and the reaction time. Acids of the strength of phosphoric acid and stronger acids such as, in particular, sulfuric acid are the strong acids here. After the surface reaction with the acid, the particles are preferably washed and finally dried prior to reaction step b).

The silicon-halogen compounds that are contacted with the oxidic particles in reaction step b) are advantageously selected from silicon chlorides and silicon bromides, for example silicon tetrachloride and silicon tetrabromide. Advantageously, the reaction is carried out in the liquid phase, however, in the most anhydrous possible medium. Consequently, the liquid phase should comprise as little water as technically possible. The water content should be below 1 ppm, for example. This ensures that the Si-halogen bonds are not hydrolyzed, or only in minor amounts, whereas the majority of the silicon-halogen molecules are bonded to the particle surface by reaction with the surface M-O—H groups. The reaction is advantageously controlled such that 1 to 3 M-O—Si bonds are formed per silicon atom, whereas 3 to 1, advantageously 1 to 2 Si-halogen bonds are conserved. These are then available for further functionalization reactions. The silicon-halogen compounds themselves, for example, that are intended for reaction with the oxidic particles, may be used as the liquid phase. They not only serve as the reagent, but simultaneously as the reaction medium. The silicon-halogen compounds may also be brought into contact with the particles of the oxidic compounds in dry, aprotic solvents. Examples of suitable aprotic solvents are cyclohexane and diethyl ether. Further aprotic solvents under consideration are liquid aromatic or aliphatic hydrocarbons, such as, for example, benzene, toluene or petroleum ether.

Such a further functionalization reaction can consist of treating the particles that were coated with a layer of silicon-halogen compounds in reaction step b) in a further reaction step c) with water under conditions such that the M-O—Si—X groups react to form M-O—Si—OH groups. The surface “silicatization” resulting from this technique can indeed also be achieved by the use of methods from the prior art; however, the upstream reaction with silicon-halogen compounds in reaction step b) affords significantly higher coating densities than obtained with conventional processes, for example according to the process of EP-A-1 284 277.

After the above hydrolysis process step, the resulting particles with their surface M-O—Si—OH groups can again be contacted with the silicon-halogen compounds in a further reaction step d), as described above. The formation of a second layer according to this technique results in M-O—Si—O—Si—X groups (wherein X represents the corresponding halogen). In this manner the coating becomes thicker, which can lead to a higher chemical stability. Both reaction steps c) and d) can now be repeated any number of times. This means that in reaction step d), the newly deposited Si—X groups can again be hydrolyzed with water, the Si—X bond being replaced by a Si—OH bond. The repeated treatment with silicon-halogen compounds in a further reaction step d) deposits the next O—Si—X layer. Any selected coating thicknesses can be built up in this way. Layers can be obtained with thicknesses significantly higher than 25 nm, for example in the range of 50 nm up to 1 μm and even higher, for example up to 25 μm.

In an alternative process, the Si—OH groups that result from a first or repeated reaction step c) are not treated again with the silicon-halogen compound, but processed such that after reaction step c), the particle is treated in a further reaction step d) with an organosilicon compound Z₍₄₋ₙ₎SiRₙ, in which Z represents a hydrolyzable group, n means a number in the range 1 to 3 and R represents an organic group, bonded to the Si through a carbon atom, and where there are several R groups in the molecule, these may be the same or different, under reaction conditions such that M-O—Si—O—SiRₙ groups are formed by cleavage of the Z group from the M-O—Si—OH groups.

Here, Z means a hydrolyzable group bonded to silicon through oxygen, such as, for example an alcoholate group and in particular an ethanolate group. The process sequence is terminated after this reaction and ultimately affords a coating of the oxidic particles which is end-blocked with O—SiRₙ groups at the exterior. Although the employed reaction is known in the prior art, in the context of the present invention it affords a significantly denser coating with O—SiRₙ groups. In addition, any thickness of the silicate layer can be prepared between the oxidic particle surface and the external O—SiRₙ groups by using a repetitive sequence of upstream steps: hydrolysis of the Si-halogen bonds and repeated reaction with silicon-halogen compounds.

A further alternative process is that after the reaction step b) or after a reaction step d), the particles are brought into contact in a further reaction step e), with at least one organic compound or a hydride source, under conditions such that Si—X bonds are cleaved and bonds between Si and the organic compound or to a group thereof or to a hydrogen atom are formed.

In order to prevent the Si—X bonds being hydrolyzed to Si—OH bonds in said reaction step e), conditions of the lowest possible water content must be employed, as was the case in reaction step b). The reaction conditions described above for reaction step b) also apply for this reaction step e). Examples of corresponding reactions carried out on silicon dioxide particles possessing surface Si—Cl groups are cited in the article by Giesenberg et al. in Angew. Chem. Int. Ed., discussed in the introduction, as well as in the previously unpublished European Patent application cited therein with the application number 03 024 279.6. The details given there can be similarly applied to the present invention, the particles of oxidic compounds that are precoated in the partial steps b) or d) being used instead of the silicon dioxide particles. Both of the cited documents also contain in-depth information concerning how the particles obtained from reaction step e) can be analytically characterized in detail. The information presented there can also be analogously applied to the present invention.

Naturally, not only a single appropriate organic compound can be used in reaction step e), but rather a mixture of different compounds. This then results in oxidic particles that carry different organic groups on their surface.

If a hydride source, such as, for example LiAlH₄ is used in reaction step e), then the surface Si—X bonds are replaced by Si—H bonds.

In reaction step e), if it is desired to use reactive organic compounds that can cleave the Si—X bond, then compounds are used as reactants that either carry at least one acidic hydrogen or that possess at least one positively polarized organic group R. Examples of the latter are Grignard reagents of the type R—Mg—X (X=halogen) or alkyllithiums of the type Li—R. Examples of organic compounds with an acidic hydrogen atom are alcohols, primary or secondary amines or primary or secondary phosphanes.

Accordingly, the reaction step e) is preferably characterized in that the organic compound is selected from R—OH, RNH₂, R₂NH, RPH₂, R₂PH, R—Mg—X, Li—R, a wherein X represents a halogen atom and R an organic or organosilicon group, and where there are several R groups in the molecule, these may be the same or different.

Independently of the manner in which the Si—R group on the surface is ultimately produced, it is preferred that at least one R group possesses at least one C═C double bond or at least one epoxy group. The particles, coated in this way, can then, as is well known from the prior art, be firmly bonded into an organic matrix such as for example a paint, as on curing, the C═C double bonds or the epoxy groups of the R group react chemically with the matrix. For example, the group R can represent a butadiene group, thereby enabling such coated particles to bond into a rubber matrix.

In a further aspect, the present invention generally relates to particles that are obtained according to the process described above. In a general sense, the present invention relates to particles of oxidic compounds of metals and/or semimetals M that do not contain exclusively silicon as the metal or semimetal M, and whose surface is modified such that they carry —Si—OH groups, —Si—X groups (X=halogen) and/or —Si—Y groups (Y=an organic group that can be linked to the Si through a carbon atom or a heteroatom) in a density of at least 2, preferably at least 3, particularly at least 4 of such groups per nm² of surface.

The density of the silicon-containing groups per nm² of surface is thus significantly higher for the inventive oxidic particles than could be achieved by the previous methods. In favorable cases, the density of the silicon-containing groups on the surface is at least 5, in particular at least 6.

When the silicon-containing groups on the surface are —Si—Y groups, then the achievable coating density of the surface may depend on the steric requirements of the Y groups: the bulkier the groups, the less find room per nm² of surface. On the other hand, with large groups Y, a lower number of these groups per nm² of surface is needed for at least widely covering the surface. If the organic groups Y are characterized by their number of carbon atoms, then such particles in accordance with the invention would carry such a number of —Si—Y groups that per nm² surface, at least 4, preferably at least 6 and particularly at least 8 carbon atoms of the organic groups Y are present. From this point of view, the present invention also relates to particles of oxidic compounds of metals and/or semimetals M that do not contain exclusively silicon as the metal or semimetal M, and whose surface is modified such that they carry —Si—Y groups (Y=an organic group that comprises carbon atoms and which can be linked to the Si through a carbon atom or a heteroatom) in such a density per nm² of surface that per nm² of surface, at least 4 carbon atoms of the organic groups Y are present. In this connection, such particles, in increasing order of preference, have at least 6 carbon atoms, at least 8 carbon atoms, at least 12 carbon atoms, at least 16 carbon atoms, at least 20 carbon atoms, at least 24 carbon atoms, at least 28 carbon atoms, at least 32 carbon atoms from the organic groups Y per nm² of surface.

In order to determine the coating density per nm², the particle surface and if necessary the porosity is first measured by the BET Method (for example, using nitrogen). The total content of organic groups or carbon atoms therein and/or of silicon on the particles can be determined by elemental analysis. Thermogravimetric analysis and/or DSC measurements can be used for the latter. In a thermogravimetric analysis in the presence of air, the organic groups burn at higher temperature and thus result in a weight loss. This combustion reaction is seen as an exothermic effect in a DSC measurement. For confirmation, a comparison can be made with a thermogravimetric analysis and/or DSC measurement of the starting material that was not coated with the silicon-containing groups. If the chemical nature of the organic groups and their number per Si atom are known, then the total number of the organic groups in moles and therefore the coating density can be determined from the weight loss. This analysis can be supported or supplemented for a combustion analysis by trapping the carbon dioxide and water resulting from the combustion of the organic groups and back-calculating the number of the organic groups from the collected amounts. When the chemical nature of the organic group and/or their number per Si atom is unknown for an unknown sample, then at least the number of carbon atoms per nm² can be determined from this type of analysis. In addition, mass spectroscopy techniques can be employed to determine the chemical nature of the organic groups. The coating density per nm2 can be calculated from the correlation of the resulting total quantity of coating groups or carbon atoms with the measured particle surface. Further details can be found in the cited article of Giesenberg et al. and the EP patent application cited therein.

Both the above references also contain more detailed information concerning which organic compounds can be reacted with the surface Si—X groups under which reaction conditions. These are wholly applicable to the present invention, so that for these examples and reaction conditions, reference is made to the cited article of Giesenberg et al. and to the European patent application cited therein.

In particular, with respect to the inventive particles, it also holds true that they preferably carry —Si—Y groups on the surface, wherein Y means an organic group that possesses at least one C═C double bond or at least one epoxy group. The advantages of such groups for linking the coated particles into an organic matrix were described earlier.

Possible Uses

1. Reinforcing Fillers

Reinforcing fillers significantly improve the properties of organic polymers. Their effectiveness depends to a great extent on the linkage of the incorporated inorganic particles to the surrounding, mostly organic matrix. Such particles that carry substituents on their surface, which exhibit a chemical similarity towards the surrounding matrix, are preferred; those that can form a strong covalent bond with the matrix are particularly preferred. This can be achieved, for example, when the substituent on the particle surface is an unsaturated organic group, quite particularly preferably a group that represents the monomer of the surrounding polymer matrix.

2. Catalyst Supports

The efficiency of catalysts in heterogeneous catalysis is determined to a large extent by the magnitude of their surface. A solid binding of catalytically active atoms, molecules or particles on the surface of small particles is desirable. Both “hard” atoms or groups of atoms or “soft” atoms or groups of atoms (using the definition of Pearsson) can be catalytically active. For example, amino groups on the particle surface are able to bond to a “hard” atom and phosphane groups, for example, are able to bond to a “soft” atom. The functionalization of the surface can be carried out on particles of any size, morphology and specific surface.

3. Pigments

The application possibilities of pigment particles in paints and related products not only depend on their optical properties, but also to a large extent on their dispersibility in them and linkages into the respective inorganic or organic medium. Depending on the respective requirements, the functionalization of the surface can be carried out on particles of any size, morphology and specific surface.

4. Mechanical Property Requirements

Particularly hard inorganic particles, such as, for example, aluminum oxide (corundum) are used in the form of composites as tools (e.g. grindstones), for example, or also as grinding agents or polishing media. Here as well, the strength of the linkage to the matrix or the grinding support, exerts a very strong influence on the properties of the material. Depending on the respective requirements, the functionalization of the surface can be carried out on particles of any size, morphology and specific surface.

5. Magnetic Property Requirements

Various fields of application come into consideration for ferro-, ferri-magnetic or superparamagnetic particles: magnetic polymers, ferrofluorides with high exposure times and in particular medical applications: if magnetic particles could be successfully bound to the surface of active ingredients, then in principle, these could be conducted, by means of a magnetic field, into a part of the body where they are intended to be deployed. Similar developments are under development elsewhere and the first particles are already commercially available. The method that we have described requires little time and effort, is cost effective and the binding of active ingredients to this type of modified metal oxides should be easily possible.

Superparamagnetic particles enable in principle almost inertia-free switchable magnetic states that are conceivable for applications as cheap mass storage devices.

Accordingly, the inventively manufactured or inventive particles can find a variety of application possibilities and supersede conventionally hydrophobic treated or functionalized particles of oxidic compounds that are manufactured by conventional methods and which are therefore less highly coated than the particles in accordance with the present invention.

Thus, the present invention additionally encompasses the use of the inventively manufactured or inventive particles for different uses and in different media. For example, the invention includes the use of these types of particle as components of catalysts (e.g., as supports for the real catalytically active components) or as materials for chromatography. In addition, the invention includes the use of these types of particles in agents for application on skin or hair, for example in sun screening agents. For this application, oxidic particles are preferably chosen that in particular strongly absorb UV-radiation. Examples of these are titanium dioxide, tin dioxide and zinc oxide. Titanium dioxide is a particularly good absorber of UV-radiation. However, it has the disadvantage of being photocatalytically active when irradiated and triggers unwanted side reactions either in the composition itself or on the skin and/or hair. This unwanted characteristic is strongly repressed by the inventive coating.

The invention further relates to the use of the inventively manufactured or inventive particles in a matrix of organic polymers. This includes the use as color pigments, light protecting pigments or anti-corrosion pigments in paints and the use as reinforcing fillers or fillers in rubber and other types of rubbers, in adhesives, sealants as well as in plastic films or moldings. Paints or plastics often comprise titanium dioxide as light-protecting pigments. Due to the unwanted photocatalytic activity, reactions can also occur that destroy the organic matrix. The inventive coating considerably inhibits these reactions with the result that the life of the plastic part or a titanium dioxide-containing paint is significantly increased. By their use as reinforcing fillers or fillers, the increased coating layers lead to improved tear strengths.

The invention further relates to the use of inventively coated or inventive particles as grinding components in grinding agents or polishing agents. For this, the oxidic particles must be hard enough to be suitable for this purpose. Examples are aluminum oxides, particularly corundum. As a result of their inventive coating, the oxidic particles can be significantly better distributed in the matrix of the grinding agent or polishing agent. They are more finely distributed and more strongly bound than conventionally coated particles, whereby firstly the lifetime of the corresponding grinding agent or polishing agent is increased and secondly, because of the finer distribution of the grinding particles, a more even grinding or polishing result is achieved. The roughness of the ground or polished surface is thereby reduced.

When the oxidic particles have magnetic properties, as is the case with iron oxides (e.g., magnetite), nickel oxides and specific mixed oxides, then they can be used as magnetic components in a liquid, coatable or solid magnetic preparation. In particular, they can be suspended in a carrier liquid to form a so-called ferrofluid. These ferrofluids can be guided by means of magnetic forces to designated places, where they are intended to deploy their activity. Such ferrofluids are known in the prior art. The inventive improved coating allows the magnetic particles to remain better distributed, such that ferrofluids are obtained that are stabilized against phase separation.

A last aspect of the present invention generally includes any material that comprises distributed inventive or inventively manufactured particles. Examples of the nature and uses of these materials emanate from the abovementioned application possibilities.

Advantages:

The inventive process is characterized by several advantages over the prior art:
1. Firstly, in contrast to current processes of the prior art, the inventive process can handle basic chemicals. Up to now, processes for surface modification according to the prior art always required specialty chemicals such as, e.g., organosilanes. This implies not only a limitation of the functionalization possibilities but at the same time also higher costs. In the inventively described process, basic chemicals such as, e.g., sulfuric acid, hydrochloric acid and silicon tetrachloride or silicon tetrabromide as well as organic and also organometallic reagents such as, e.g., alcohols, Grignard reagents and alkyllithium reagents are preferably used. As a great number of reagents can be used for functionalization, the inventive processes, in contrast to the processes of the prior art, make accessible many new functionalities on appropriately described particle surfaces.
2. The density of functional groups per nm² on the respective particle surfaces can be increased by means of the inventive pre-treatment of the abovementioned particles. This is achieved by slightly etching the respective particles with appropriate mineral acids. This step increases the number of OH groups on the particle surface, and provides the basis for a dense coating of the respective surfaces with functional groups in the subsequent functionalization step. In this way, not only a higher degree of functionality is generated on the respective particle surfaces, leading in general to an improvement in the properties of the respective particles for the corresponding field of use, but also the particles are protected from attack by other chemicals or materials.
3. After the respective particles have been etched, they are preferably treated with silicon tetrabromide or particularly preferably with silicon tetrachloride. The OH groups on the respective particle surfaces react with silicon tetrabromide or silicon tetrachloride affording the corresponding silicon-halogen bonds that can be further substituted by other substituents, preferably organic groups.
4. By simple hydrolysis of the silicon-halogen bonds with water and repeated treatment with silicon tetrabromide or silicon tetrachloride, a silicon dioxide layer is successively built up on the particle surface. The thickness of the layer is determined by the number of repeats. A silicon dioxide layer generated in this way on the surface of the above-described particles protects the surface from chemicals and other detrimental influences.
   Theory and Experimental

The experimental execution of the inventive process is described below using an example of a metal oxide particle (MeₓO_{y}): In the first step, OH groups were generated or their number increased on the surface of the metal oxide particles The valences of the surface atoms must also be totally satisfied with salt-like substances such as metal oxides. For oxides, this is mostly carried out by replacing the O²⁻ ions on the surface of the particles by OH⁻ ions, although their number can be very small. This number can be decisively increased by etching the surface with acid.

In a second step, the OH groups on the metal oxide surface are then treated with silicon tetrachloride, such that Me-O—SiCl₃ groups are formed by hydrolysis of a Si—Cl bond on the particle surface. During the reaction with SiCl₄, it is of great importance to work under dry experimental conditions with respect to the equipment and chemicals. The reaction of Me-OH with SiCl₄ is described in Reaction Sequence 1, below:

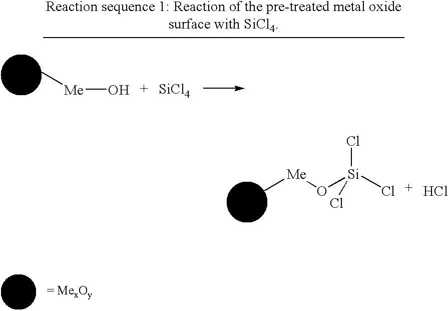

In the propagational sense, there results a molecular chlorosiloxane layer on the metal oxide surface, which in the following will be referred to as MeO—CSN. This allows all prior art functionalization methods to be used again, firstly by substitution of the halogen atom by other substituents, preferably organic groups, secondly with ethoxy silanes or halogenosilanes after hydrolysis. An example of a synthesis for an inventive surface modification of a silicon chloride-treated metal oxide particle with an alkyltrichlorosilane is shown in Reaction Sequence 2 below. 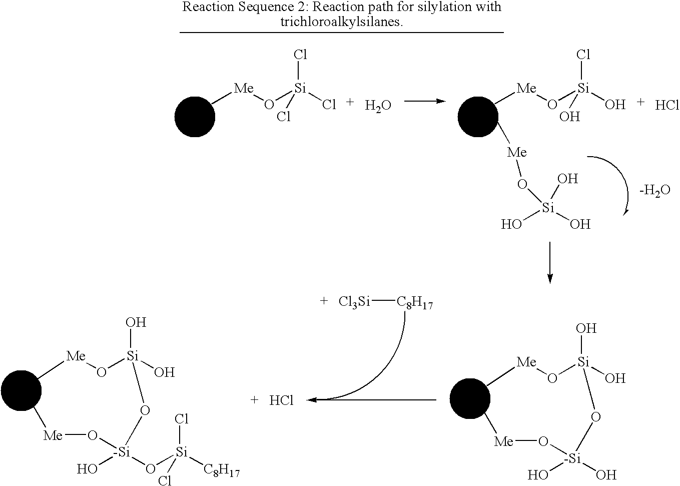
General Experimental Description

For pre-treatment, the oxidic materials were distributed in concentrated sulfuric acid and etched for a period of 4 hours under stirring. They were then worked up by separating the solid from the sulfuric acid by means of a glass sinter (Po. 3) and subsequently washed with distilled water to pH 7, then with diethyl ether and dried under vacuum (10⁻² mbar). The resulting dry solid was then heated under reflux with silicon tetrachloride for 12 hours. The work up procedure described above was repeated. The intermediate product was then distributed in cyclohexane under dry reaction conditions and subjected to reaction by slowly adding an excess of octyltrichlorosilane. The reaction mixture was refluxed for 12 hours. After cooling, the product was separated from the reaction mixture through a glass sinter (Po. 3) and then washed with 3×30 mL cyclohexane, 3×30 mL distilled water and 2×30 mL diethyl ether. Drying under vacuum (ca. 10⁻² mbar) afforded a hydrophobic powder

Experimental Procedure for the Surface Modification with SiCl₄ and Octanol

Pre-Treatment of the Alcohol:

Dry molecular sieve (3 Å) was added to octanol in a flame-dried Schlenk flask and stored. The required alcohol was withdrawn with a syringe under a counter current.

General Reaction Procedure:

The dry solid (e.g., titanium dioxide) was heated with silicon tetrachloride in an inert atmosphere under reflux for 12 hours. The SiCl₄ was then separated by filtration under inert gas and then dried under vacuum (ca. 10^{×2} mbar); the resulting solid was placed in a Schlenk flask for the reaction with the alcohol.

An approximate twofold excess of alcohol, based on the expected amount of Cl atoms on the surface particles, was used for the further functionalization. Octanol and ½ eq. triethylamine (based on the added octanol) were added to the solid suspended in THF. The suspension was heated under reflux with stirring for 12 hours under inert gas.

The solid was then filtered off under inert gas and dried under vacuum (ca. 10⁻² mbar) for several hours.

The determination of the octanol groups in the coating on rutile (TiO₂), reacted according to the above procedure with SiCl₄ and then with octanol, was carried out as described below. The specific surface area (BET method) of the reaction product was 10 to 12 m²/g. The carbon content was determined from a combustion analysis and, bearing in mind the experimental imprecision, was calculated to be about 40 to 55 carbon atoms per nm². The octyl group coating density was therefore about 5 to 7 groups per nm².

General Method for the Calculation of the Coating Density of a Particle Surface with Organic Groups —CₙH₂ₙ₊₁:

The BET surface area F_{BET} (m²/g) and the carbon content by weight w(C) (%) are required and can be determined by analysis, for example. The number of moles n(R) of organic groups R comprised in an amount of material of weight m (g) are expressed as:
n(R)=w(C)/(100·n(C)·M(C))=w(C)I(100·n(C)·12)
n(C) being the number of carbon atoms in the organic group; for an octyl group, n(C)=8. M(C) is the atomic weight of carbon (12 g/mol). Therefore, for this case:
n(Octyl)=w(C)/(100·8·12)=w(C)/(100·96)

In order to calculate the number of octyl groups N(octyl), this value has to be multiplied by the Avogadro constant:
N(octyl)=6.02·10²³·w(C)/(100·96)

Dividing this value by the specific surface area F_{BET} (m²/g), gives the number of octyl groups per m², and by dividing by (10⁻⁹)², the number of octyl groups per nm². Therefore:
N(octyl)/nm²=[6.02·(10²³/10¹⁸)·w(C)/(100·96)]/F_{BET}
N(octyl)/nm²=[w(C)/F_{BET}]62.7
w(C) is in % and F_{BET} is to be inserted in m²/g.

Research demonstrates that this coating thickness is greater, the smaller and less sterically demanding is the group R. The highest value is attained when R=−CH₃.

What is claimed is:

1. A process for modifying the surface of particles of oxidic compounds of metals and/or semimetals M, having M-O—H groups on the surface thereof, and which do not exclusively comprise silicon as the metal or semimetal M, said process comprising a reaction step b) wherein particles are brought into contact with one or more silicon-halogen compounds under conditions such that the M-O—H groups react with the one or more silicon-halogen compounds to afford M-O—Si—X groups (X=halogen).

2. A process according to claim 1, wherein the particles of oxidic compounds of metals and/or semimetals M, prior to the reaction step b), are contacted in a reaction step a) with a strong acid.

3. A process according to claim 1, wherein the particles, after the reaction step b), are brought into contact in a further reaction step c) with water under conditions such that the M-O—Si—X groups react to form M-O—Si—OH groups.

4. A process according to claim 3, wherein the particles, after the reaction step c), are reacted in a further reaction step d) with an organosilicon compound Z₍₄₋ₙ₎SiRₙ,
in which Z represents a hydrolyzable group;
n means a number in the range 1 to 3; and
R represents an organic group, bonded to the Si through a carbon atom, wherein when n is a number greater than 1 the R groups in the molecule are the same or different;
under such reaction conditions that M-O—Si—O—SiRₙ groups are formed by cleavage of the Z group from the M-O—Si—OH groups.

5. A process according to claim 3, wherein the particles, after the reaction step c), are brought into contact in a further reaction step d) with silicon-halogen compounds under conditions such that the —O—Si—OH groups react with the silicon-halogen compounds to form —O—Si—O—Si—X groups (X=halogen).

6. A process according to claim 1, wherein the particles of oxidic compounds of metals and/or semimetals M, prior to the reaction step b), are contacted in a reaction step a) with a strong acid and wherein the particles, after the reaction step b), are brought into contact in a further reaction step c) with water under conditions such that the M-O—Si—X groups react to form M-O—Si—OH groups.

7. A process according to claim 6, wherein the particles, after the reaction step c), are reacted in a further reaction step d) with an organosilicon compound Z₍₄₋ₙ₎SiRₙ,
in which Z represents a hydrolyzable group;
n means a number in the range 1 to 3; and
R represents an organic group, bonded to the Si through a carbon atom, wherein when n is a number greater than 1 the R groups in the molecule are the same or different;
under such reaction conditions that M-O—Si—O—SiRₙ groups are formed by cleavage of the Z group from the M-O—Si—OH groups.

8. A process according to claim 6, wherein the particles, after the reaction step c), are brought into contact in a further reaction step d) with silicon-halogen compounds under conditions such that the —O—Si—OH groups react with the silicon-halogen compounds to form —O—Si—O—Si—X groups (X=halogen).

9. A process according to claim 1, wherein after reaction step b) the particles are brought into contact in a further reaction step e) with at least one organic compound or a hydride source under conditions such that Si—X bonds are cleaved and, instead, bonds between Si and the organic compound or to a group thereof or to a hydrogen atom are formed.

10. A process according to claim 9, wherein the organic compound is selected from R—OH, RNH₂, R₂NH, RPH₂, R₂PH, R—Mg—X, Li—R, wherein X represents a halogen atom and R an organic or organosilicon group and, when there are a plurality of R groups in the molecule, said R groups can be the same or different.

11. A process according to claim 10, wherein at least one R group possesses at least one C═C double bond or at least one epoxy group.

12. A process according to claim 9, wherein the particles of oxidic compounds of metals and/or semimetals M, prior to the reaction step b), are contacted in a reaction step a) with a strong acid.

13. A process according to claim 9, wherein the particles of oxidic compounds of metals and/or semimetals M, after reaction step b) and before reaction step e) are contacted with water in a further reaction step c) under conditions such that the M-O—Si—X groups react to form M-O—Si—OH groups and reacted in a further reaction step d) with at least one compound selected from the group consisting of silicon-halogen compounds and organosilicon compounds Z₍₄₋ₙ₎SiRₙ,
in which Z represents a hydrolyzable group;
n means a number in the range 1 to 3; and
R represents an organic group, bonded to the Si through a carbon atom, wherein when n is a number greater than 1 the R groups in the molecule are the same or different.

14. Particles of oxidic compounds of metals and/or semimetals M that do not contain exclusively silicon as the metal or semimetal M, and whose surfaces are modified such that said surfaces carry —Si—OH groups, —Si—X groups (X=halogen) and/or —Si—Y groups (wherein Y is an organic group that can be linked to the Si through a carbon atom or a heteroatom) in a density of at least 2 such groups per nm² of surface and/or said surfaces carry —Si—Y groups (wherein Y is an organic group that comprises carbon atoms and which can be linked to the Si through a carbon atom or a heteroatom) in such a density per nm² of surface that at least 4 carbon atoms of the organic groups Y are present per nm² of surface.

15. Particles according to claim 14, wherein said particles carry —Si—Y groups on the surface where the organic group Y possesses at least one C═C double bond or at least one epoxy group.

16. A catalyst comprising one or more catalytically active components and a support containing particles according to claim 14.

17. A composition comprising a matrix of one or more organic polymers and particles according to claim 14.

18. A ferrofluid comprising a carrier liquid and particles according to claim 14, wherein said particles have magnetic properties.

19. A method of grinding or polishing a surface, said method comprising using a grinding or polishing agent containing particles according to claim 14.
